(19) United States
(12) Patent Application Publication
(10) Pub. No.: US 2008/0005907 A1
(43) Pub. Date: Jan. 10, 2008

(54) DUCTILE IRON BEVELING TOOL

(76) Inventor: Douglas Scheffer, Marysville, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/769,552

(22) Filed: Jun. 27, 2007

Related U.S. Application Data
(60) Provisional application No. 60/806,087, filed on Jun. 28, 2006.

(51) Int. Cl. B23D 21/06

(52) U.S. Cl. 30/94; 29/33 T

(57) ABSTRACT

A tool bevel member for ductile iron which is adapted to perform a cutting operation and also a beveling operation on a ductile metallic pipe such as a ductile iron pipe. There is a rotary power saw which has rotary drive member to which a saw blade can be mounted. The bevel section can be removably connected to the drive member of the power saw.

### CROSS-REFERENCE RELATED APPLICATIONS

The present application is a converted provisional application 60/806,087 filed Jun. 28, 2006 to a full application pursuant to 37 CFR 1.53(c)(3) and further claims the priority of Ser. No. 10/619,016 now U.S. Pat. No. 7,103,950 filed Jul. 11, 2003 which claims U.S. provisional patent application 60/395,483, filed Jul. 11, 2002.

### BACKGROUND

In general, as shown in the original application there is an embodiment which is adapted to bevel the end of a pipe. However, there are numerous iron types of pipes in the public domain and require beveling around the perimeter region.

Traditional repositioning or cutting of metal is often done by a grinding tie process where an abrasive material with an abrasive compound and a resin format such as silicon dioxide is utilized to remove portions of metal in a fine dust-like environment where you see the characteristic sparks. However, the end goal of the result of the beveled pipe is the removal of a perimeter portion. Therefore, having a cutting, slicing-like action which can be utilized with conventional tools in a beveling process as described in application Ser. No. 10/619,016 is desirable for various applications.

In the prior art, large pipes are used to transport liquids or gas, and these can very substantially in size, with some of these being as large as one to two feet in diameter, or possibly larger. Sometimes they have to be cut to different lengths and joined end to end in some manner, and this often requires beveling the end edge portion of the pipe.

One common method of cutting these pipes is to use a rotary power saw which has a rear hand grip section and a front cutting section. At the cutting section, there is a disc saw blade which is mounted about an axis of rotation that is transversely aligned relative to a forward to rear axis of the power tool. It is common practice in the industry to sometimes bevel the end to edge portion of the pipe by using the saw blade of this same rotary power saw to make the beveled cut around the circumference of the end edge of the pipe section. This is a somewhat difficult task, and is particularly difficult to provide a relatively uniform beveled surface at the proper angle.

### BRIEF DESCRIPTION OF THE DRAWINGS

FIG. 1 is an isometric view showing a prior art rotary power saw beveling the edge of a plastic pipe;

FIG. 2 is a sectional view taken along line 2-2 of FIG. 1, showing the 5 disc saw blade of the cutting tool of FIG. 1 cutting a bevel into the end edge portion of the pipe;

FIG. 3 is side elevational view showing the tool assembly of the present invention performing a beveling operation around the outside of the end edge portion of a pipe;

FIG. 4 is a cross-sectional view, partly in section, similar to FIG. 3, but drawn to an enlarged scale, showing the bevel section of the tool assembly of the present invention performing the beveling operation;

FIG. 5 is an exploded cross-sectional view partly in section, showing the mounting section and the locating portion of the beveling portion of the bevel section;

FIG. 6 is an exploded cross-sectional view similar to FIG. 5, showing the bevel section of the second embodiment of the present invention;

FIG. 7 is a cross-sectional view of the components of FIG. 6 in their assembled operating condition;

FIG. 8 is a view the same as FIG. 7, except there is also shown a cover cap in a location removed from the beveling section; and

FIG. 9 is a view similar to FIG. 8, but showing the end cover cap in its covering position over the beveling tool;

FIGS. 10 and 11 are cross-sectional views similar to FIG. 7, with portions of components within the locating member being omitted for purposes of illustration, and with FIG. 10 showing the operating position of the bevel member in a lower position, and FIG. 11 showing the bevel member in a higher location to accomplish bevel cuts of different size;

FIG. 12 is a sectional view of the mounting portion of the bevel section of the second embodiment showing various dimensions;

FIG. 13 is a top plan view of FIG. 12;

FIG. 14 is a somewhat schematic view of the bevel member of the second embodiment giving various dimensions;

FIG. 15 shows an isometric view of a ductile iron cutting bit;

FIG. 16 shows a side view of the ductile iron cutting bit:

FIG. 17A shows a cross-sectional view taken at line 17A-17A in FIG. 16:

FIG. 17B shows a close-up view of an insert cutter;

FIG. 18A shows a cross-sectional view taken at line FIG. 18A-18A of FIG. 16:

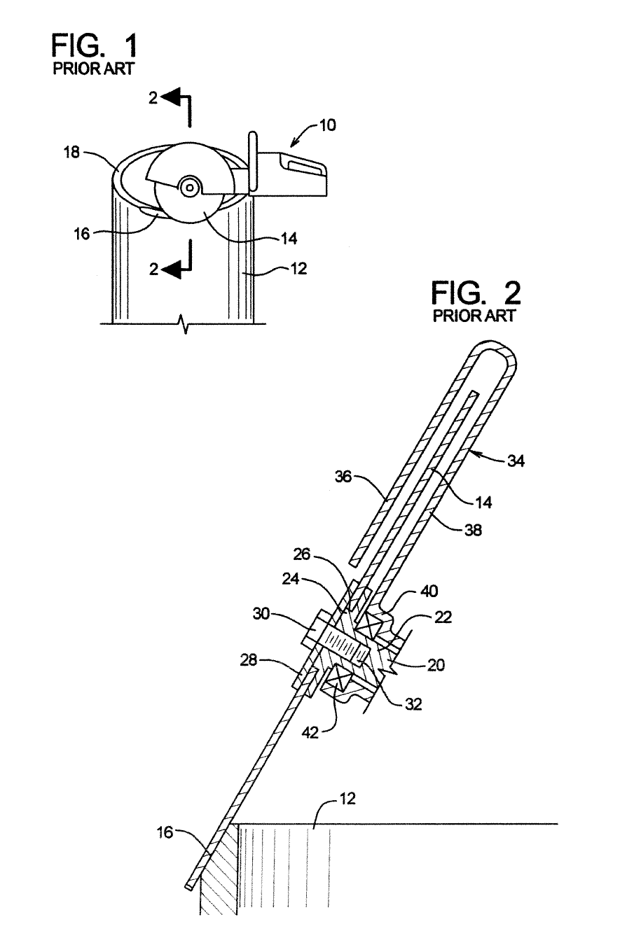

FIG. 1 8B shows a close-up view of the cutter insert in a longitudinally outward orientation;

FIG. 19 schematically shows the orientation of a cutter insert in the angle with respect to a longitudinal reference axis;

FIG. 20 shows a core portion of the ductile iron cutting bit; and

FIG. 21 shows a schematic alternative version of the cutting insert.

### DESCRIPTION OF THE EMBODIMENTS OF THE PRESENT INVENTION

The method and apparatus of the embodiments of the present invention are able to accomplish the cutting of a pipe or the like, and also beveling an end portion of the same. A first embodiment comprises a rotary power saw section and also a bevel section.

The rotary section comprises a rear handle grip portion which is adapted to be manually grasped, and a forward saw portion having a saw mounting portion with a rotary drive member to which a rotary blade can be mounted. The rotary drive member has a transverse axis of rotation. In a configuration of the first embodiment, the rotary power saw section can be considered as having a front end, a rear end, and a front-to-rear longitudinal axis, with the transverse axis of rotation having a substantial alignment component perpendicular to the longitudinal axis.

The bevel section comprises a mounting portion and a bevel cutting portion. The mounting section is arranged to be connected to the rotary drive member so as to be rotatable therewith, and the bevel cutting section is connected to the mounting section so as to be rotatable therewith. The bevel section further comprises a bevel member adapted to be located in an operating position to bevel a pipe end portion.

The bevel cutting section has a locating surface portion rotatable with the bevel section. This locating surface is located adjacent to the bevel member, and in its operating position it engages the pipe end edge portion to locate the bevel section.

The bevel cutting section comprises a locating member having an edge portion which comprises the positioning surface which extends around the axis of rotation of the bevel member and is positioned radially outwardly of the bevel member.

The bevel member and the locating member can be adjustably moveable relative to one another along the axis of rotation of the bevel member. The locating member comprises a sidewall which defines a recess in which to receive the bevel member. Also, the locating member may be adjustably mounted to the mounting section, so as to be able to be positioned at different locations along the axis of rotation of the bevel member. Also, the locating member may threadedly engage the mounting member. Further, the bevel member may connect to the mounting section so that the relative locations of the bevel member and the locating member can be modified by adjustably moving the locating member relative to the mounting section.

The bevel member in one form has a threaded connection portion that connects to a threaded socket in the drive member. In another form, the mounting section has a collet connecting portion to engage the bevel member.

The bevel member has a slanting cone-shaped cutting surface, with a larger diameter base end portion and an apex end portion. The bevel member in one form has adjacent its apex end a lateral positioning member which has a surrounding positioning surface to engage a sidewall of the pipe on which the beveling operation is being performed.

One configuration of the bevel section is such that the mounting section has a threaded end connection adapted to engage the rotary drive member, so as to be rotatable therewith. Also, there is an intermediate threaded portion having a first end portion connected to the threaded end connector and a bevel end connecting portion connected to the intermediate threaded portion.

Also in this configuration, there is a bevel cutting section comprising the bevel member having a bevel connecting member portion arranged to be connected to the bevel end connecting portion of the mounting section.

In an embodiment of a method of the present invention, there is provided the rotary power saw section and the bevel section as described above. The mounting section of the bevel section is connected to the rotary drive member, and the power saw is positioned so that the bevel member is adjacent to the end edge portion of the pipe. The locating surface is positioned against the end edge portion of the pipe.

The rotary power saw is operated to rotate the drive member and thus rotate the bevel member. The rotary power saw is moved so that the bevel section moves around the end edge portion of the pipe to form to form the bevel surface with the locating surface portion engaging the end edge portion to properly locate the bevel member. Further, there may also be the lateral positioning member to engage the sidewall of the pipe during the cutting operation.

It is believed that a clearer understanding of the present invention will be obtained by first describing, with reference to FIGS. 1 and 2, a common prior art method of making a beveled cut in the end edge portion of a plastic pipe or the like, and then describing in detail the embodiments of the present invention.

With reference to FIG. 1, the prior art method is shown where there is a prior art rotary power saw 10 which is positioned to perform a beveling operation on a section of a pipe 12. The power saw 10 has a disc-shaped saw blade 14 making a bevel cut 16 on the outside of an end edge portion 18 of the pipe 12.

FIG. 2 is a cross-sectional view of FIG. 1 showing the manner in which the saw blade 14 is mounted to the power saw 10. The power saw 10 has a transversely extending drive shaft 20 with a blade mounting portion 22 that comprises a hub 24 having an annular recess 26. The central opening of the saw blade 14 fits in the annular recess 26 so as to center the saw blade, and a washer 28 bears against the adjacent surface of the inner portion of the saw blade 14. A bolt 30 is inserted into a threaded socket 32 formed in the outer end of the drive shaft 20, and this presses the inside circumference portion of the saw blade 14 against the outer portions of the hub 24 so as to secure the saw blade 14 to the drive shaft 20.

There is a guard member 34 which fits over the upper half of the saw blade 14. The guard member 34 comprises a pair of generally semi-circular shaped plates 36 and 38 positioned on opposite sides of the upper portion of the saw blade 14, and joined together at their curved outer edge portions. The inner portion of the plate 38 is formed integrally with a mounting portion 40 that extends around the drive shaft 20. There is a bearing member 42 which is positioned around the shaft 20, with this bearing member 42 engaging the guard member mounting portion 40 to properly locate the guard member 34 relative to the shaft 20, and to enable the shaft 20 to freely rotate.

Thus, it can be seen that the prior art method, shown in FIG. 1, is using the same rotary power saw 10 that is used in cutting through the entire circumference of the pipe 12 to saw off a section of the pipe 12. The pipe 12 is positioned (vertically as shown in FIG. 1) so that the end edge 18 is located so that it is accessible to being cut in the manner shown in FIG. 1. More specifically, the handles of the power saw 10 are grasped and the power saw 10 is operated in an angled position so that the saw blade 14 makes the beveled cut around the outer edge of the end edge portion 18 of the pipe 12.

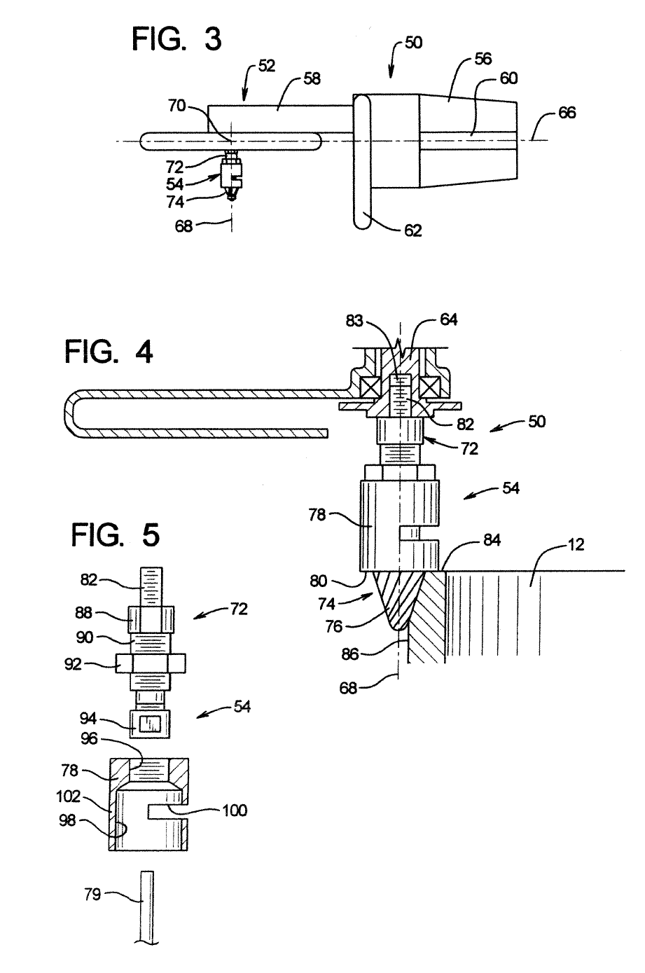

With the foregoing description of one prior art method of making the bevel 16 on the pipe 12 (as seen in FIGS. 1 and 2) being completed, there will now be a description of the first embodiment of the present invention. There will first be a general description of the overall configuration of the present invention and its operation, and this will be done with reference to FIGS. 3 and 4. After that is completed, then there will be a more detailed description of the components and features of this first embodiment of the present invention.

The tool assembly 50 of the present invention comprises a rotary output power section 52 and a bevel section 54. As indicated previously in this text, in the two embodiments of the present invention, described and shown herein, an existing prior art rotary power saw can be used as the rotary power output section 52 with little or no modification to the rotary power saw. This will be described more fully later herein.

In describing the tool assembly 50, since some of the components of the rotary output power section 52 are, or may be, identical (or substantially similar) to corresponding components in the prior art rotary power saw 10. In describing these components as they appear in the tool assembly 50 of the present invention, numerical designations differing from the corresponding components in the prior art power saw 10 will be given to those components that appear in the tool assembly 50. This is done so that there is not confusion in determining whether reference is being made to a certain component as it appears in the prior art power saw 10 or in the power tool assembly 50 of the present invention.

The power section 50 comprises a rear hand grip portion 56 and a forward drive section 58. The handle grip portion 56 comprises a rear operating handle 60 and a forward stabilizing handle 62. This hand grip arrangement is typical of those that can be found in a number of hand-held power tools such as chainsaws, the rotary power saw 10 (described above), etc. There is a drive shaft 64 (see FIG. 4) positioned in the drive section 58, and this drive shaft 64 is or may be the very same drive shaft 20 shown in FIG. 2 in the rotary power saw.

The rotary output power section 52 can be considered as having a longitudinal axis 66, extending in a rear to forward direction through the hand grip section 56 and through the drive section 58 at the location of the center of rotation of the drive shaft 64, a transverse axis 68 which is concentric with a center of rotation of the drive shaft 64 and transverse to the longitudinal axis 66, and a vertical axis 70 perpendicular to the both the longitudinal axis and the transverse axis.

The beveling section 54 is shown in its operating position in FIG. 4, and this comprises a mounting section 72 by which the beveling section 54 is connected to the drive shaft 64, and a bevel cutting section 74 connected to the mounting section 72 so as to be rotatable therewith.

The bevel cutting section 74 further comprises a bevel member 76 which performs the actual bevel cutting operation, and a locating member 78 that provides a locating surface 80 that properly positions the bevel member 76 relative to the end edge 18 of the pipe on which the beveling operation is being performed. The bevel member 76 is fixedly connected at its upper center portion to a shaft 79 by which the bevel member 76 connects to the lower end of the lower end of the mounting section 74. For ease of illustration, the shaft 79 is not shown in FIG. 4, but is shown in the exploded view of FIG. 5.

This description of the tool assembly 50 given thus far describing the components 52 through 80 is given as a general overview of the tool assembly 50, and the operation of the tool assembly 50 will now be described with reference to FIGS. 2, 3, and 4.

In the following description, the terms “upper” and “lower” shall refer to the orientation of the tool assembly 50 and the pipe 12 as seen in FIG. 2. The terms “inward” and “outer” shall refer to a direction toward or a direction away from, respectively, the longitudinal center axis of the pipe 12. Also, the terms “inner” and “outer” shall denote locations nearer to or further from, respectively, the longitudinal center axis of the pipe 12. On the assumption that the rotary output power section 52 of the tool assembly 50 of the present invention is basically the same as the prior art rotary power saw 10 shown in FIGS. 1 and 2, there will now be a description of the manner in which the rotary power saw 12 is adapted to function as the rotary power section 52 of the tool assembly of this first embodiment of the present invention. This is accomplished by removing the retaining bolt 30 shown in FIG. 2, and then connecting the bevel section 54 to the shaft 20 of the rotary power saw 10 by means of a threaded end connector 82 of the mounting section 72 which is inserted into the existing threaded socket 83 in the end of the drive shaft 64. As shown in FIG. 4, the saw blade 14 and the washer 28 have also been removed. As another option, the blade 14 and/or the washer 28 can remain in place, and when the bevel section 54 is in place, as shown in FIG. 4, the bevel section 54 would simply press against the washer 28 or directly against the blade 14 to hold the blade 14 in its normal position in the rotary power saw 10.

To describe now the operation of the tool assembly 50, with the pipe 12 being vertically aligned, the tool assembly 50 is positioned so that the transverse axis 68 of the tool assembly is vertically aligned so as to be parallel to the longitudinal center line of the pipe 12.

To cut the bevel 16 in the end to edge portion 38 of the pipe 12, the tool assembly 50 is positioned as shown in FIG. 4, with the locating surface 80 of the locating member 78 resting on the transverse edge surface 84 (shown as an “upper” surface in the orientation of FIG. 4) with the bevel member 76 positioned adjacent to the outer circumferential side surface 86.

Then, when the rotary output power section 52 is operated to cause rotation of the drive shaft 64, the bevel member 76 is moved around the upper circumferential edge 84 of the pipe 12 to cut the beveled surface 16.

With the immediately preceding text giving a general overview of the structure and functioning of this first embodiment of the present invention, there will now be a more detailed description of various components of the first embodiment and features of the same.

Reference is first made to FIG. 5, which is an exploded view of the mounting section 72 and also of the locating member 78 of the bevel cutting section 74. The mounting section 72 comprises the aforementioned threaded end connector 82 which is at the upper end of the mounting section 72. Immediately below the threaded end connection, there is a flat sided portion 88, which in this configuration has in transverse section two diametrically opposed flat surfaces and which is, or may be, formed integrally with the end connector 82. Connected to and extending downwardly from the flat sided portion 88 is a second intermediate cylindrical threaded portion 90, and a lock nut 92 threadedly engages the threaded portion 90 so as to be able to be rotated and moved upwardly and downwardly on the immediate threaded portion 90.

Below the intermediate threaded portion 90 is a collet member 94 which is fixedly connected to the mounting section 80. The threaded end connector 82, the flat sided portion 88, the intermediate threaded portion 90, and possibly a stationary portion of the collet member 94 are, or may be, made as a single integral piece or could be made as separate components joined to one another. This collet member 94 receives the shaft 79 which is rigidly connected to the upper center portion of the bevel member 76. The flat sided portion 88 can be conveniently gripped with a wrench or some other tool so that the mounting section 72 can be rotated to cause the threaded end connector 82 to be securely connected into the threaded socket 83 formed in the end of the shaft 64. The intermediate threaded portion 90 serves the function of permitting the nut 92 to be threaded for upward and downward positioning, so that the nut 92 serves as a lock nut for the locating member 78. Further, this intermediate threaded section 90 provides a means for adjustable connecting to the locating member 78.

The aforementioned locating member 78 has, or may have, a generally cylindrical configuration, and has at its upper end a threaded opening 96 which is sized to threadedly engage the threads of the intermediate threaded portion 90 of the mounting section 72. Immediately below the threaded opening 96 there is a cylindrical chamber or receptacle 98 which has a diameter slightly larger than the diameter of the widest portion of the bevel member 76. Thus, the upper portion of the bevel member 76 can be moved upwardly into the chamber 98, and this configuration is shown in FIG. 4.

There is a slot-like opening 100 which is formed in the side wall 102 which is at the lower part of the locating member 78. This slot-like opening 100 is formed in approximately semi-circle and is dimensioned so that a tool can be inserted through the opening 100 to tighten or loosen the collet member 94. In the lower part of the exploded view of FIG. 5, there is shown an upper portion of the bevel member connecting shaft 79 which connects to the upper end of the bevel member 76. This connecting shaft 79 extends into the collet member 94 where it can be secured by the collet member 94 so as to properly position the bevel member 76 in the bevel section 54.

The bevel member 76 is, or may be, conventional in and of itself, and as shown herein the bevel member 76 has a cone-shaped configuration with the base of the cone connecting to the aforementioned connecting shaft 79.

To explain now the manner in which the bevel section 54 is assembled and placed in its operating position, the bevel section 54 is assembled by connecting the locating member 78 to the mounting section 72. This is accomplished by causing the threaded opening 96 of the locating member 78 to be threaded onto the lower part of the intermediate threaded portion 90 of the mounting section 72. When this is accomplished, then the lock nut 79 can be rotated downwardly into engagement with the upper surface of the locating member 72 to keep it in the desired position. The bevel member 76 is placed in its assembled position by inserting the connecting shaft 79 of the bevel member 76 into the collet member 94, and then tightening the collet member 64 to grip the connecting shaft 79 by placing the proper tool into the slot 100 to engage the collet member 94, and cause the collet member 94 to go into its locking position.

With the bevel section 54 thus assembled, the bevel section 52 is then connected by means of its threaded end connector 82 into the recess 83 of the drive shaft 64 of the rotary output power section 52. As indicated previously in this text, on the assumption that the rotary output power section is the same as, or similar to, the prior art rotary power saw 10, the bolt 30 of the rotary power saw 10 is unthreaded from its matching socket, and the washer 28 and/or the saw blade 14 may be removed or left in place. In either case, the threaded end connector 82 is threaded into engagement in the socket 83 so that the bevel section 54 is tightly engaged with the shaft 64. A wrench can be applied to the flat sided portion 88 to apply sufficient torque to ensure proper engagement. Then, the tool assembly 50 can be operated in the manner as described above with reference to FIGS. 3 and 4.

It is to be understood that the various terms that are used in describing this first embodiment, as well as the items in the description that follows relative to the second embodiment, are not to be interpreted so as to limit the scope of the claims to the literal definition of those terms. For example, a certain component or a member may be given a singular designation, but it quite possibly may well be within the broader scope that any single member or component could be made as a plurality of such members or components, and not be outside the scope of the present invention. Further, it could be that one or more members or components that are described in the text of this application could be combined into one component or member, instead of having these as separate components or members. For example, for efficiency and the economy of the manufacturing process, it may be designed to make a particular component into two parts which are joined together in an assembly, instead of being made as an integral part. Also, the relative positions, mode of attachments, mode of engagements or other functions are described to disclose to the reader how these are arranged in these embodiments and are not necessarily to be interpreted that these are the only configurations and arrangements, and are not necessarily to be interpreted that these are the only configurations, locations, relative dimensions, etc. For example, there could be a socket member could have a male member of a fitting, or a different joining method may be used. Further, such components as a locating or bearing member that perform a function or other components which performs a certain function could have the function accomplished by some other component bearing a quite different name but yet might serve the same functional relationship (or a very similar functional relationship), and be within the broader scope of the present invention, these terms should be so interpreted. For example, there could be a plug and socket connection where one member has the plug and the other has the socket, and there could be a reversal of parts as to which component is on which member. Also, different connecting means could quite possibly be used.

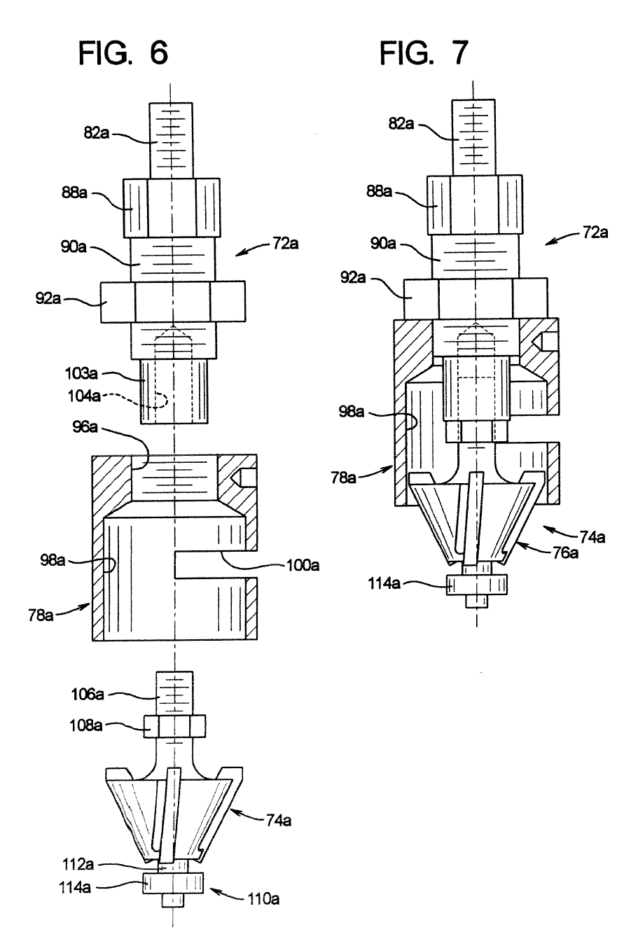

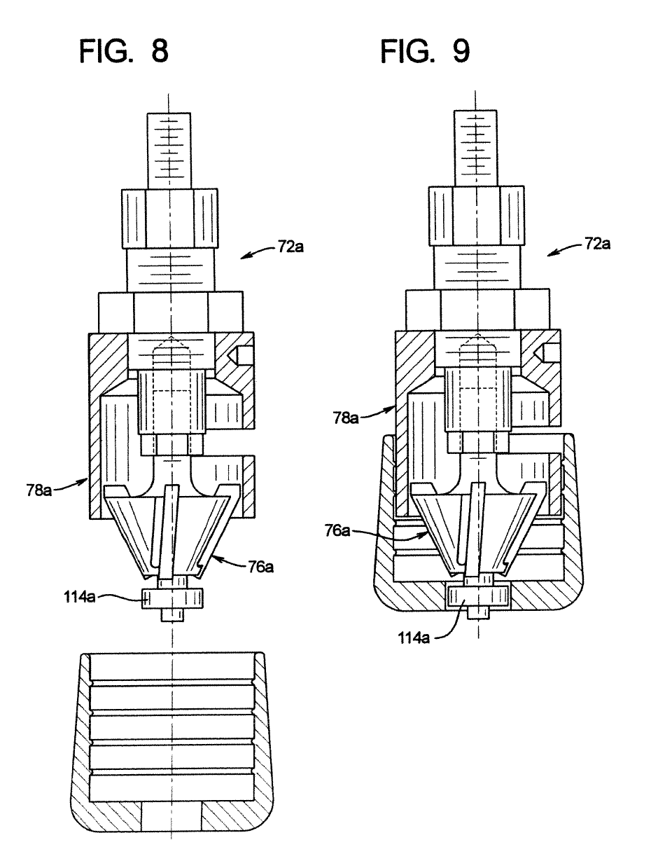

A second embodiment of the present invention shows FIGS. 6-9. Components of the second embodiment which are the same as, or similar to, components of the first embodiment will be given like numerical designations, with an “a” suffix distinguishing those of this second embodiment.

This second embodiment of the present invention is a tool assembly 50, and has the two basic sections as in the first embodiment, namely a rotary output power section 52 and a bevel section 54. The rotary output power section 52 of this second embodiment is, or may be, exactly the same as in the first embodiment, or at least similar thereto. Accordingly, this rotary output power section of the second embodiment is not shown in FIGS. 6-9.

This bevel section 54a of the second embodiment differs in some respects from the bevel section 54 of the first embodiment. It comprises a mounting section 72a and a bevel cutting section 74. The mounting section 72a has a threaded end connector 82a, the flat sided portion 88a, the intermediate threaded portion 90a, and the lock nut 92a. However, instead of having a lower collet, as shown at 94 in FIG. 5 of the first embodiment, there is a bevel connecting member 103a which is made integrally with or otherwise connected to, the intermediate threaded portion 90a, and which has a downwardly facing cylindrical threaded recess 104a.

The locating member 78a has the same configuration as the locating member 78 of the first embodiment. However, there could be modifications in the configuration to adapt this locating member 78a to this particular design of the second embodiment, such as changing dimensions, etc.

The bevel member 76a has, or may have, the same or similar configuration as the bevel member 76 of the first embodiment. However, instead of having the unthreaded connecting shaft 79 that connects to the collet member 94, the bevel member 76a has a threaded cylindrical connecting member 106a which is sized to fit in the socket 104a of the connecting member 94a of the mounting section 72a. Thus, the connection of the bevel member 76a to the connector 94a is by means of a threaded connection where the threaded connector 106a is threaded into the socket 104a. Further, a lock nut 108a is threaded onto the connector 94a. Thus, when the connector 94a is threaded into the socket 106a the proper distance, the lock nut 108a can be threaded up into firm engagement with the connector 104a to securely hold the bevel member 76a in place. This can be accomplished by inserting a tool through the slot-like opening which is shown at 100a.

A further feature of the second embodiment is that at the lower end of the bevel member 76a there is a downwardly extending lateral positioning portion 110a, which comprises a downwardly extending finger 112a on which is mounted a roller bearing 114a having a cylindrical positioning surface. This roller bearing 114a engages the side surface 86 of the pipe 12 for lateral positioning of the bevel member 76.

To describe now the functional relationships of the second embodiment, the locating member 78a is threaded onto the intermediate threaded portion 90a the desired distance, and then the lock nut 92a is rotated into firm engagement with the upper surface of the locating member 78a to hold it securely in place. Then, the bevel member 76a is threaded into the socket 106a, a desired distance, and then the lock nut 108a locks the connector 94a into the socket 106a, thus fixing the vertical position of the bevel member 76a.

Thus, the relative positions of the bevel member 76a and the locating member 78a can be controlled so that the locating surface 80a can be positioned to be a predetermined distance relative to the bottom end of the bevel member 76a. Also, the lateral positioning of the bevel member 76a relative to the outside surface of the pipe 16 is established by the outer surface of the bearing member 114a. The combination of the positioning of the locating surface 80a and the surface of the bearing 114a determines the vertical dimension of the bevel 16 relative to the locating member 78, and establishes the vertical and lateral dimension of the bevel cut 16 into the upper end portion of the pipe 12.

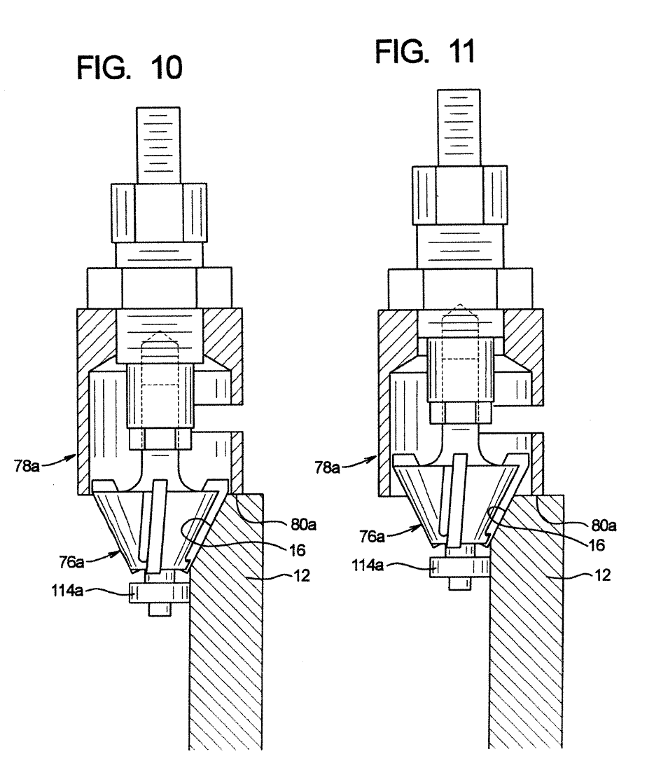

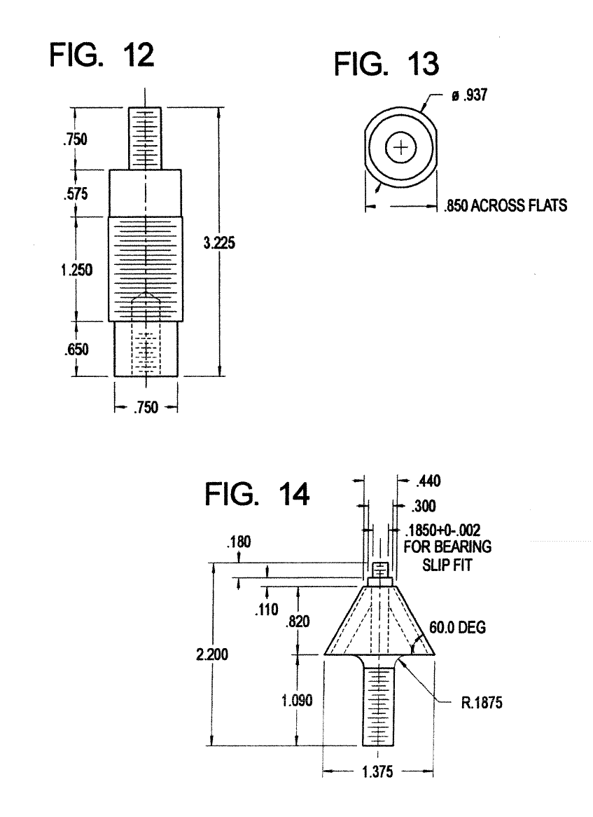

This feature is illustrated in FIGS. 10 and 11. For ease of illustration, the components within the chamber of the locating member 78a are omitted from the drawings of FIGS. 10 and 11. In FIG. 10, the collet member 76a is at a lower position, and it can be seen that the bevel 16 being cut is further into the width of the pipe 12, and also has a greater vertical distance. On the other hand, in FIG. 11, the collet member 76a is at a higher position, and thus the bevel cut 16 is smaller in both its lateral and vertical dimensions.

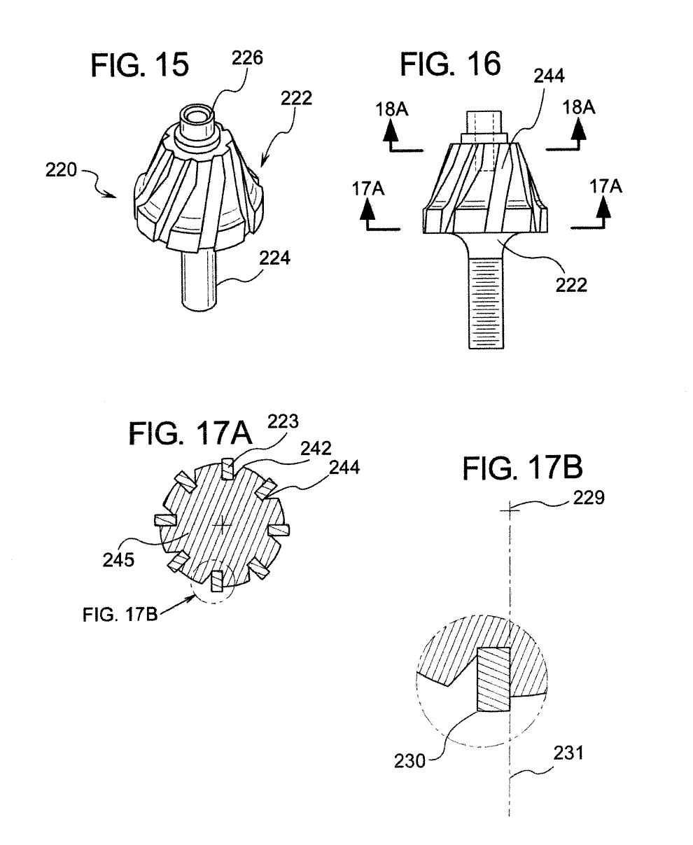

As shown in FIG. 15, there is an isometric view of a ductile bit 220. In general, the ductile bit has a cutting region 222, a shaft region 224 and a guide bearing 226. As shown in FIG. 16, there is a side view of the cutting bit. The cutting bit can be used with or without the surrounding locating member 78 as shown in the previous embodiment.

FIG. 2 shows two cross-sectional lines 17A-17A and 18A-18A. As shown in FIG. 17A, there is a portion of the side view which is looking along one of the cutting elements. Reference is now directed to the forward leading surface 230 in FIG. 17B which is at an angle from a radial plane line 232 as shown in FIG. 19 indicated at θ. For example, this angle can be one degree or thereabouts from this referenced radially extending line.

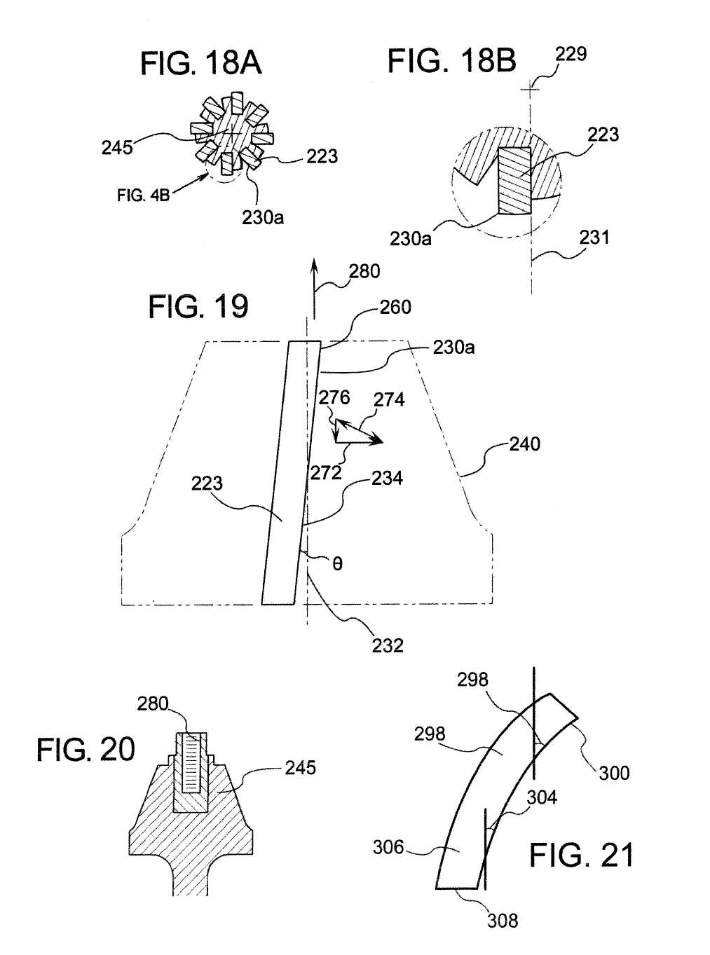

Now referring to FIG. 17A, this cross-sectional view is taken at the more longitudinally outward region from the cutting bit and is represented by one cross-sectional view of one cutting element at FIG. 16. FIG. 18B shows the leading edge 230a where it can be seen that this portion is at a greater angle from radial reference line 231 than the edge portion 230 with respect to the center 229 in FIG. 17B.

Present analysis and experimentation have found that having this relationship and change of angle creates a longitudinal thrust of the tool inward to the pipe being beveled. This is very desirable and makes the cutting shearing action of the pipe more smooth, and allows the mechanical energy from the motor to properly guide the cutting bit therearound the perimeter region with less and less needed interaction of the user. Further, this longitudinal inward thrust of the bit by this dynamic action of the cutting when the forward edge surface and the cutting edge 234 dynamically act to bring this longitudinal inward action which is much safer for the user of the tool.

It should be noted that the sliver creation when cutting which is created has been found to not induce sparks in the cutting action. In fact, the slivers tend to be of a rather sufficient size, much larger than that of pulverized ground metal from a grinding operation. Further, the lack of sparks indicates a sufficiently low temperature where energy is not wasted on heating the particulate metallic material. However, if heat is sufficiently generated, the carbide bit does tend to operate better. The lack of generation of excessive heat is rather important, as it is well-known in metallurgical disciplines that carbide will break down and lose its ceramic properties at say above 600° F. However, the present operation of the metallic cutting bit, it has been found that the lower temperature does not break down the carbide and in fact tends to be in a sweet spot of between 400-500° F., and present analysis indicates approximately about 440° F., which is a very desirable temperature range for cutting the metal. Of course this analysis does not include having detailed temperature readings and these are merely approximations and the best sufficient guess given our present current analysis.

Referring back to FIG. 19, the radially outward edge surface 240 is substantially frustoconical in shape with respect to the center longitudinal axis. As shown in FIG. 17A, the trailing edge 242 dips radially inwardly toward the center axis of the tool to the core portion 244 which essentially does not engage the metal but needs to be sufficiently radially inwardly to provide clearance so the next adjacent trailing cutting element can engage the pipe surface. The recessed region 244 is an area that allows the cutting insert/member 223 to be inserted therein. However, present analysis indicates that there may be a desirable benefit of the recessed area 244 where it allows a desirable buildup or desirable area for sliver metallic shards to build up to be ejected outwardly during a cutting operation as they are centrifugally thrown outwardly after the cut. This is merely speculation on the applicant's behalf at this time; however, present analysis indicates that the set up as shown these figures has the desirable effect of ejecting the shards without any sufficient interference in the next cut as the tool rotates 360°.

It should be further noted that the longitudinally inward region as shown at line 18A-18A of FIG. 16 is cutting more metal per rotation because this is the beveled region at the outward portion of the pipe where metal is removed. Therefore, empirical analysis has indicated that having the θ value as shown in FIG. 19 to have a desirable effect of allowing a more aggressive shard cut at this portion and which has a desirable effect of not dulling the blade as quickly. Of course, the guide surface as described further herein can adjust the amount of laterally longitudinally inward depth of the tool with respect to the forward edge surface of the plate to the proper desirable bevel.

Now referring to FIG. 19, there is a view taken along the side profile of the tool. As shown in this figure, the cutting bit 223 is shown and a reference line 232 is extending radially outward from the center longitudinal axis 229. As shown in this figure, the leading cutting surface edge point 234 is angled in a sloping rearward direction from the longitudinally forward portion to the longitudinally rearward portion. This angle which may not be linear and constant with respect to the various portions along the longitudinal axis is referred to as θ as introduced above. The theta value, which is 2° from the reference line/plane 232 in one form, has been found to have desirable effects for several technical reasons. Firstly, it should be noted that as the bit rotates in the positive cutting direction, the longitudinally outward portion 260 is the first area to engage the metal. This first portion as it first engages and sizes the metal and breaks the shard portion from the base metallic surface. Once this initial breakage occurs, there is more of a shearing action as the metal sliver develops from the longitudinally outward region to the longitudinally inward region of the bevel and essentially is sliced off. As mentioned above, there has been some initial concern that the shard is not developed at one point of a simultaneously rotation value but is formed as the cutting bit rotates therearound. Of course at a 2-degree theta value as shown in FIG. 19, this slicing action form the longitudinally outward portion to the longitudinally inward portion happens relatively quickly and of course at a fairly high rpm value of say about 5500 to 5800 rotations per minute. However, because the development of the shard is not simultaneous, but rather done over some value of time (albeit small), this tends to have a desirable effect of forming the waste shards/slivers where their formation is more averaged out in the course of a single rotation then if they were formed in a more boullion-like manner in discrete chunks given the number of bits of cutting elements within a cutting bit.

Another benefit which is indicated by present analysis of having the angled surface 232 as shown in FIG. 19, is this action as the tool rotates in the positive/cutting direction indicated at 233. Essentially, as the metal of the pipe to beveled is struck by the outer portion first and the angle tends to pull the unit towards the pipe that is being beveled. As the portion of the leading edge indicated at 230a engages the ductile metal pipe, you can see from the force vector diagram that there is a resultant force indicated at 274. This resultant force broken down into its constituent force vectors has a longitudinal force component 276 which essentially pulls the tool in the opposing direction. In other words, if you view the cutting element 223 as a stand blade for example, the sweeping action as the blade progresses through the metal basically pulls the entire blade bit in the direction indicated at 280. This of course has a desirable effect where instead of having the user have to thrust the blade longitudinally inward to the part, the mechanical energy does this on its own.

FIG. 20 shows a cross-sectional view where a bearing rod insert receiving surface 280 is threadedly engaged into the core 244. A bearing sits in the laterally longitudinally outward portion thereof. It should be noted that the depth of the tapped-out portion should not be too deep to compromise the structural integrity of the core.

FIG. 21 shows various other geometries and sweet spots of the orientation and positioning and dimensions of the various cutting elements. For example, as shown in FIG. 21, there is an exaggerated view of a ductile iron bit 298 where the forward portion 300 has a certain alpha angle 302 that is less than the alpha angle 304. Further, along the side profile, as shown in there may be a more desirable contour with the outer surface 306 having concave-like attribute. In other words, the upper region 308 of the concave portion will produce a more desirable rounded edge in the pipe.

It is to be understood that various modifications could be made to the embodiments described herein, and that these could well be within the scope of the claims which follow this text.

1. A pipe beveling member for a rotary drive member to bevel a ductile pipe: end edge portion of the pipe, said tool assembly comprising:
a ductile iron bevel section comprising a mounting section arranged to be connected to the rotary drive member so as to be rotatable therewith,
a bevel cutting section connected to the mounting section so as to be rotatable therewith and comprising a bevel member having an axis of rotation adapted to be located in an operating position to bevel the pipe end edge portion configured to create metallic slivers of the ductile pipe,
a locating surface portion rotatable with said bevel section, and located adjacent to said bevel member in its operating position to engage the pipe end edge portion to locate said bevel section wherein said bevel cutting section comprises a locating member having an end edge portion which comprises said locating surface portion which extends around the bevel member,
said bevel member and said locating member are adjustably movable relative to one another along said axis of rotation of said bevel member and said locating member comprises a side wall which defines a recess in which to receive said bevel member.

2. The assembly as recited in claim 1, wherein said locating member is adjustably mounted to said mounting section, so as to be able to be positioned at different locations along the axis of rotation of the bevel member by repositioning a connecting member that is connected to the bevel member to the mounting section.

3. The assembly as recited in claim 1, wherein the bevel cutting section comprises carbide cutters that do not heat up above 500° F. during operation.

4. The assembly as recited in claim 1 where the wherein the bevel cutting section comprises carbide cutters having 2-degree theta value with respect to the axis of rotation of the bevel section.

5. The assembly as recited in claim 4 where the bevel member has a threaded connecting portion which connects to a threaded socket in said drive member.

6. The assembly as recited in claim 1 where the mounting section has a collet connecting portion to engage said bevel member.

7. The assembly as recited in claim 1 where the bevel member has a slanting cone-shaped cutting surface, having a larger diameter base end portion and a apex end portion, said bevel member having adjacent its apex end a lateral positioning member which has a surrounding positioning surface to engage a side wall of a pipe on which a beveling operation is being performed.

8. The assembly as recited in claim 7, wherein said assembly comprises a locating member which provides said locating surface portion which extends circumferentially around said locating member, said locating member being movably adjustable along an axis of rotation of said mounting section and said bevel member by repositioning a connecting member that is connected to the bevel member to the mounting section.

13. A method of beveling an end edge portion of a ductile metal pipe, said method comprising:
a) providing a rotary power saw wherein said rotary power saw section comprises:
i) a rear handle grip portion which is adapted to be manually,
ii) a forward saw portion having a saw mounting portion with a rotary drive member to which a rotary saw blade can be mounted, said rotary drive member having a transverse axis of rotation about a center axis of rotation of the rotary drive member;
b) providing a bevel section comprising a mounting section and a bevel cutting section connected to said mounting section, with said bevel cutting section having a locating surface and a bevel member wherein said bevel cutting section comprises a locating member having an end edge portion which comprises said locating surface portion which extends around the axis of rotation of said bevel member, said bevel member and said locating member are adjustably movable relative to one another along said axis of rotation of said bevel member and said locating member comprises a side wall which defines a recess in which to receive said bevel member;
c) connecting said mounting section to said rotary drive member so that said mounting section and said bevel cutting section with said bevel member and said locating surface rotate with said drive member;
d) positioning said rotary power saw so that said bevel member is adjacent to the end edge portion of the pipe and said locating surface is positioned against said end edge portion of the pipe;
e) operating said rotary power saw to rotate said drive member and thus rotate said bevel member;
f) moving said rotary power saw so that said bevel section moves around the end edge portion of the pipe to form a bevel surface creating sliver members not inducing any substantial amount of sparks where the locating surface portion engaging the end edge portion to properly locate the bevel member.

14. The method as recited in claim 13, wherein said locating member threadedly engages said mounting member, said method further comprising rotating said locating member to adjust the position of the locating member.

15. The method as recited in claim 13, wherein lateral positioning of said bevel member is controlled by providing a lateral positioning member having a surrounding positioning surface to engage a sidewall of said pipe, and locating said lateral positioning member at an apex end portion of said bevel member.

16. A bevel apparatus adapted to be connected to a drive member to perform a beveling operation on a ductile metal pipe, said bevel apparatus comprises:
a) a mounting section having:
i) an end connection adapted to engage the rotary drive member so as to be rotatable therewith;
iii) a bevel end connecting portion connected to the end connection;
b) a bevel cutting section comprising:
i) a bevel member having a bevel connecting member portion arranged to be connected to the bevel end connecting portion of the mounting section;
ii) a locating member having an end edge portion which provides a locating surface portion, said locating member having a connecting portion arranged to the mounting section so as to be adjustably movable relative thereto, said locating member also having a recess in which to receive said bevel member;
iii) the bevel member having a slanted cone-shaped cutting surface having a base end portion and an apex end portion, the bevel member having a plurality of cutting elements configured to shave ductile metal from the ductile metal pipe.

18. The bevel apparatus as recited in claim 17 where the bevel member and said locating member are adjustably movable relative to one another along an axis of rotation of said bevel member.

19. The bevel apparatus as recited in claim 18 where the cutting elements have a forward leading surface which is at an angle of at least one degree from a radial plane line.

20. The bevel apparatus as recited in claim 17 where the cutting elements provide a resultant force in operation having a longitudinal force component that pulls the tool in toward the ductile metal pipe.
